(19) United States
(12) Patent Application Publication
(10) Pub. No.: US 2011/0258004 A1
(43) Pub. Date: Oct. 20, 2011

(54) Reconciliation , Automation and Tagging of Healthcare Information

(76) Inventors: Tom DEAN, Oklahoma City, OK (US); John MATTHEWS, Oklahoma City, OK (US); Todd SLOCUMB, Oklahoma City, OK (US)

(21) Appl. No.: 12/968,182

(22) Filed: Dec. 14, 2010

Related U.S. Application Data
(63) Continuation-in-part of application No. 12/759,385, filed on Apr. 13, 2010.
(60) Provisional application No. 61/286,198, filed on Dec. 14, 2009.

(51) Int. Cl. G06Q 40/00; G06Q 50/00

(52) U.S. Cl. 705/4

(57) ABSTRACT

A transaction platform that automatically reconciles and tags administrative healthcare information including transactions (claims, remittances, payments) related to a patient encounter, and makes the transactional information accessible to the provider via a portal. The reconciliation and tagging associates components of the transaction in a unique and identifiable way, and presents the associated information about the encounter in a manner that the provider can view the revenue cycle from the first transaction related to any given encounter to the final transaction related to the encounter and every payment made associated with the encounter. Payers also can view these transactions and the associated payments.

### RELATED APPLICATION

This application claims the benefit of U.S. Patent Application No. 61/286,198, filed Dec. 14, 2009.

This application is a continuation in part of U.S. patent application Ser. No. 12/759,385, filed Apr. 13, 2010.

### TECHNICAL FIELD

Embodiments herein relate to the healthcare industry and, more particularly, provide a system for accurately tagging and coordinating the administrative healthcare information related to patient encounters and the associated payments, and consolidating healthcare data for access by participants (e.g., healthcare providers, government and commercial third party payers, patients and banks) in the settlement process.

### BACKGROUND

The processing of accounts receivable information in the healthcare industry is very complex in comparison with most other industries. In most cases, a third party like the government (Medicaid or Medicare) or a private health insurance company is the primary payer for the services provided to a patient. In a great deal of cases a secondary payer health plan is involved. In many of these cases the payers may pay an amount other than the amount actually billed by the provider. In some cases, the third party payer has a contract with the provider. This contract details the amount the payer will pay for various diagnoses or treatment procedures. Many other factors affect the amount paid by the third party. Some procedures are not covered by the third party payer at all. In some cases there is a limit to the number of occurrences of the same procedure or diagnosis that will be paid by a health plan in a specified period of time. Some procedures require pre-authorization by the payer; others require a referral by another healthcare professional. In many cases, proof that the patient is eligible or actually has the insurance coverage at the time the patient is treated is also important.

Any given provider can have contracts with many different health insurance companies. Each insurance company can have many different lines or types of insurance. Each type of insurance can pay a slightly different amount for a given procedure based on the contract negotiated between the healthcare provider and the insurance company. In some cases the patient is responsible for some or all of the difference between the billed amount and the amount paid by the health plan; however, in some cases the patient is not responsible and should not be billed the balance. In some situations there is an issue with the information related to the procedure that was sent to the health plan by the healthcare provider. It is cumbersome to identify the precise amount to bill each different health plan. Therefore, healthcare providers will typically bill a standard amount for each procedure. Because of this, the provider often does not get paid the amount billed.

The factors described above combine to present a challenge for the participants in the process (e.g., the healthcare provider, the government payers, the private insurance payers, the patient, the bank that facilitates settling the various payments, etc.). Often, and for many reasons, the health plan does not pay what is billed by the provider. Depending on the reason for which the health plan does not pay a billed amount, the provider must take a number of different actions to reconcile the receivable. Some the actions include refiling the claim, appealing the claim, writing off the difference, supplying more information to the health plan, billing a subsequent payer for some or all of the difference, billing the patient, and many other potential actions. The information required to reconcile these adjustments is often in disparate locations. Some of the required transactional information may have been gathered over the phone, other information may exist on paper, and still other information may have been processed as Electronic Data Interchange (EDI) information either directly with the payer or through an intermediary usually referred to as a clearing house. Some of the transactions also have payment associated with them. The payments can take the form of a check or some sort of electronic funds transfer. The provider may be required to get information related to these payments from the banks who were involved in processing or settling the payment.

The passage of the Health Insurance Portability and Accountability Act of 1996 (HIPAA) legislation helped to provide a standard format for electronic remittance advices in the form of ANSII standard EDI. It also provided standards for the security required connected with private health information. There is a need for a HIPAA-compliant system to process transactions of the administrative healthcare system.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 shows the transaction platform as the single source for all payer remittances in a healthcare receivables environment, under an embodiment.

FIG. 2 shows example healthcare claims, remittances, and payment transactions, under an embodiment.

FIG. 3 shows an example of matching claim, remittance, and payment, under an embodiment.

FIG. 4 is a flow diagram for matching the claim, remittance, and payment, under an embodiment.

FIG. 5 is a flow diagram for matching the claim and remittance, under an embodiment.

FIG. 6 is a flow diagram for matching the remittance and payment, under an embodiment.

FIG. 7 is flow diagram of an exception flow if the remittance and payment do not match, under an embodiment.

FIG. 8 is a flow diagram for tagging using the transaction platform and the associated data that is matched, associated and viewed by the various participating parties, under an embodiment.

FIG. 9 is a block diagram of a healthcare receivables system including the valuator, under an embodiment.

FIG. 10 is a flow diagram of claim valuation, under an embodiment.

### DETAILED DESCRIPTION

Systems and methods are described herein for reconciliation, automation and tagging of administrative healthcare information, and the systems and methods are described in the context of a healthcare transaction platform, also referred to as a transaction platform. The embodiments described herein operate to reconcile and tag most or all of the transactions (especially the claims or statements, remittances, payments) related to a patient encounter and to make the transactional information accessible to the provider via a portal. The reconciliation and tagging provided by the transaction platform associates components of the transaction in a unique and identifiable way, and presents the associated information about the encounter in a manner that the provider can view the revenue cycle from the first transaction related to any given encounter to the final transaction related to the encounter and every payment made associated with the encounter. The team “healthcare” as used herein refers to any field or enterprise concerned with supplying services, equipment, and/or information for the maintenance or restoration of health.

The embodiments also enable payers to view these transactions and the associated payments. This is useful in assisting with dispute resolution between the payer and the provider. For the most part, the payer and the provider resolve disputes via telephone conversations that result in subsequent sharing of information usually involving paper that is mailed either correcting a claim (e.g., the invoice related to an encounter) or providing more information related to the claim. When the payer has access to the same information as the provider related to the encounter via the portal of an embodiment (both of the parties accessing the same information from the same source of truth), these disputes can be resolved with much less effort.

Patients can also access the information related to the encounter in an embodiment. Patients typically receive information about an encounter in the mail via a document referred to as an explanation of benefits (EOB). This document is followed up by another document that is the bill from the provider. The patient then tries to reconcile the bill with the explanation of benefits and then resolve any questions or issues over the telephone with the provider and subsequently with the insurance company. Again, in these cases the information the patient is viewing may different from the information the provider or the insurance company is viewing. The patient's questions can be easier to resolve if the patient, the provider and the third party payer are viewing the same information via the system described herein.

The systems and methods described herein are HIPAA-compliant in that they incorporate use of the HIPAA-standard format for electronic remittance advices in the form of ANSII standard EDI. The system of an embodiment translates data that is received in a non-standard format (e.g., a paper transaction, a print file, etc.) into a HIPAA standard transaction. The portal also complies with the security standards mandated by the HIPAA legislation, for example auditing viewers of any particular information related to a patient encounter as well as providing security authenticating the provider the payer and the patient related to the encounter.

In the following description, a number of features are described in detail in order to provide a more thorough understanding of the embodiments described herein. It is apparent that these embodiments may be practiced without these specific details. In other cases, well known features have not been described in detail.

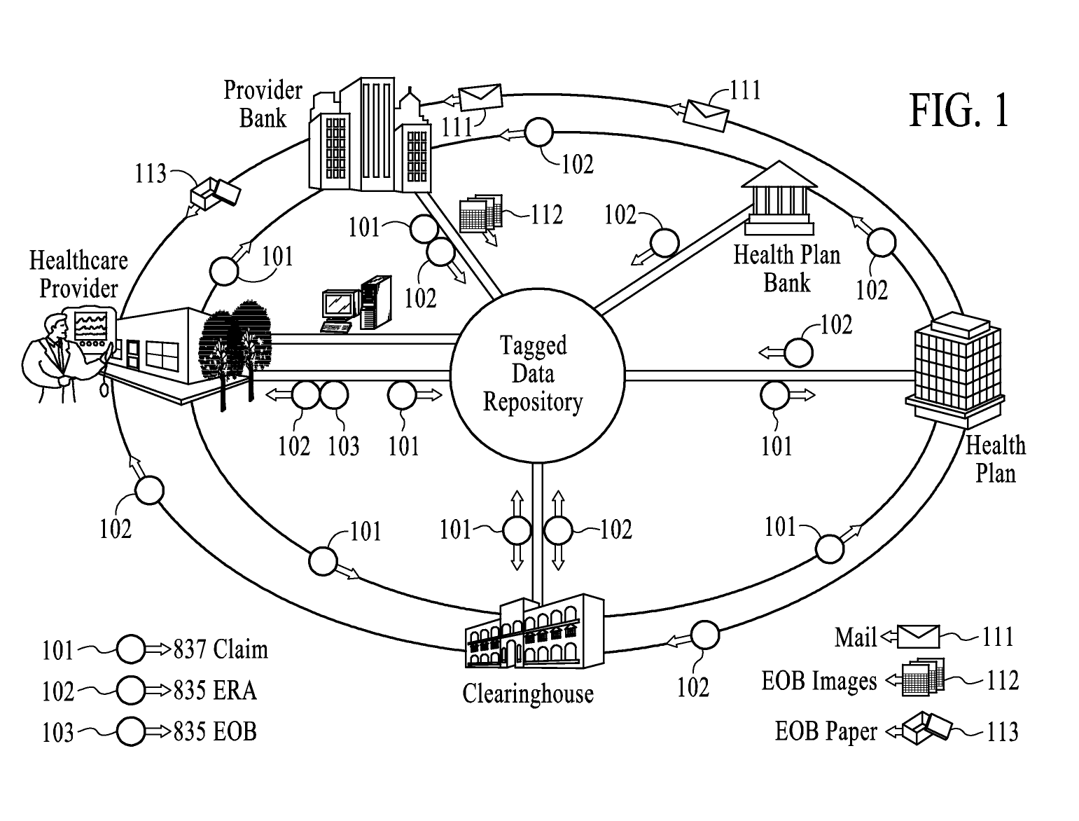

FIG. 1 shows the transaction platform as the single source for all payer remittances in a healthcare receivables environment, under an embodiment. The environment of an embodiment is compliant with the Health Insurance Portability and Accountability Act of 1996 (HIPAA) but is not so limited. HIPAA contains provisions to protect the confidentiality and security of personally-identifiable information that arises in the course of providing health care. The transaction platform securely exchanges data or participates in secure transactions with the participants in the healthcare receivables process. The transactions include but are not limited to 837 Claims Transactions (837 Claim), Electronic Remittance Advice (ERA) 835 transactions (835 ERA), ERA 835 transaction explanation of benefits (EOB) (835 EOB), and electronic funds transfer (EFT) transactions. Communications with the transaction platform and third-party systems in the transactions above are made using network couplings or connections made via public or private networks. Using the various transactions above, the transaction platform generally gathers then reconciles claims, remittance advices (electronic or paper), and the funds to deliver a balanced HIPAA compliant ERA for automated posting. The platform supports automated secondary billing, denial management, and contract management functions.

Generally, in a healthcare receivables environment, each time a patient visits their healthcare provider (patient encounter), the provider generates a claim (bill) 101 from their accounts receivable or billing system. The claim 101 goes to the primary payer, which is generally a commercial insurance company or the government. If the patient has does not have insurance or is not covered by a government program then the bill will be sent to the patient for payment. A claim 101 is generated by the patient billing system but it is not sent to a third party for payment. If the patient has insurance or is covered by a government program then a claim 101 will be sent to a third party payer or “payer” (e.g., Medicare, Medicaid, Blue Cross Blue Shield, Aetna, Cigna, etc.) for payment. The provider can send the claims 101 directly to the third party but claims 101 are usually sent from the provider to a healthcare claims clearinghouse and then the claims 101 are forwarded to the payer in the form of a HIPAA compliant format (e.g., ANSI X-12 837) for payment. When the healthcare claim 101 is sent to a payer for payment it is generally sent in one of the following formats, but is not so limited: ANSI X-12 837, UB04, CMS 1500 paper or print file, ADA form, NSF.

Turning to the Healthcare Remittance/Payment, once the claim 101 is received by the payer then it is loaded into the payers system for processing. During this processing the claim 101 is validated and then a set of rules are applied to the claim 101 in order to determine the amount to be paid to the provider. This process is called adjudication. When the payer has completed the adjudication process then adjudicated claim information is sent for use in the disbursement process.

The disbursement includes two components, the payment and remittance. Payment takes the form of a paper check, ACH, or wire transfer. The remittance takes the form of an electronic file 112 or, alternatively, a paper form 113. The paper remittance 112 is called an Explanation of Payment (EOP) or Explanation of Benefits (EOB) 103, and each payer has a uniquely formatted EOP. If the remittance is an electronic remittance advice (ERA) 102 the format is an ANSI X-12 835 or in some instances is also proprietary to the payer. The following combinations of Remittance and Payment are available, but the embodiment is not so limited: Check and EOP/EOB; ACH and EOP/EOB; Check and ERA; ACH and ERA.

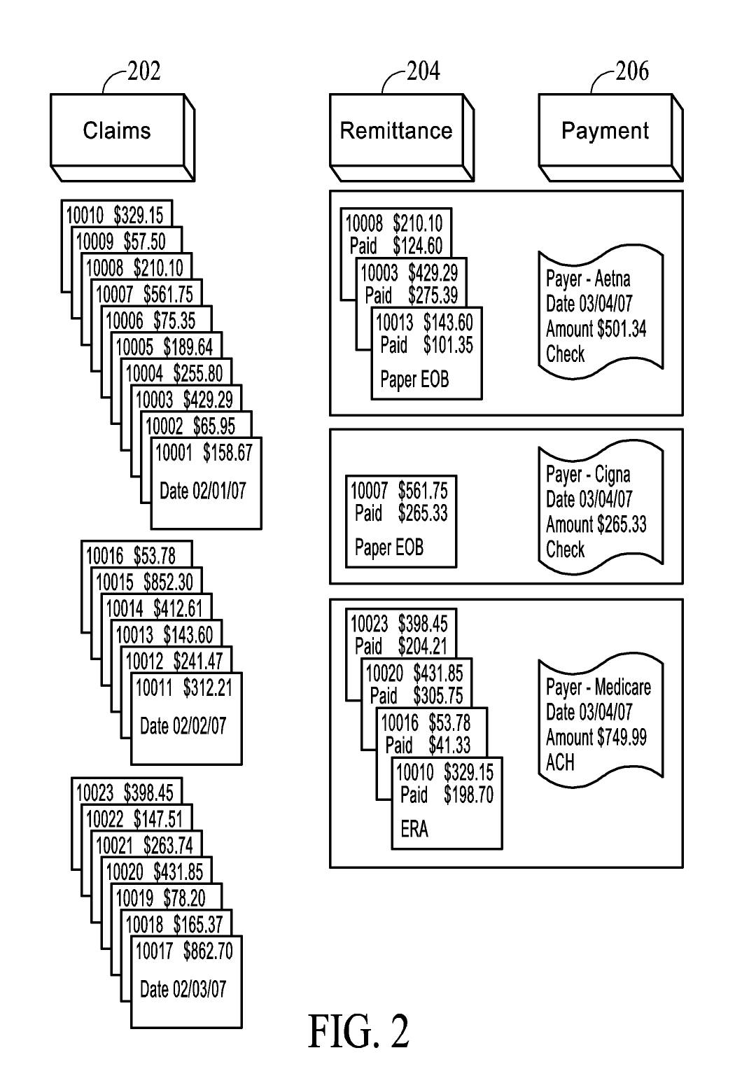

Remittances are generally originated from a single payer. Each remittance can include a payment for a single claim. Each remittance can also include have a consolidated payment for multiple claims or patient encounters, where the consolidated payment comprises multiple payments for individual claims. FIG. 2 shows example healthcare claims 202, Remittances 204, and Payments 206 or Payment Transactions, under an embodiment.

The embodiments automate the process of reconciling the healthcare payment transactions by using a three-way matching process that matches the Claim to the Remittance, then matches the Remittance to the Payment, and uniquely tags the resultant information so that it can be either associated with other information (e.g., contracts between insurance companies and providers, contracts between insurance companies and patients, other administrative transactions, etc.) and/or viewed by the patient, healthcare provider, payer(s), or bank involved in either the patient encounter, the remittance or the payment.

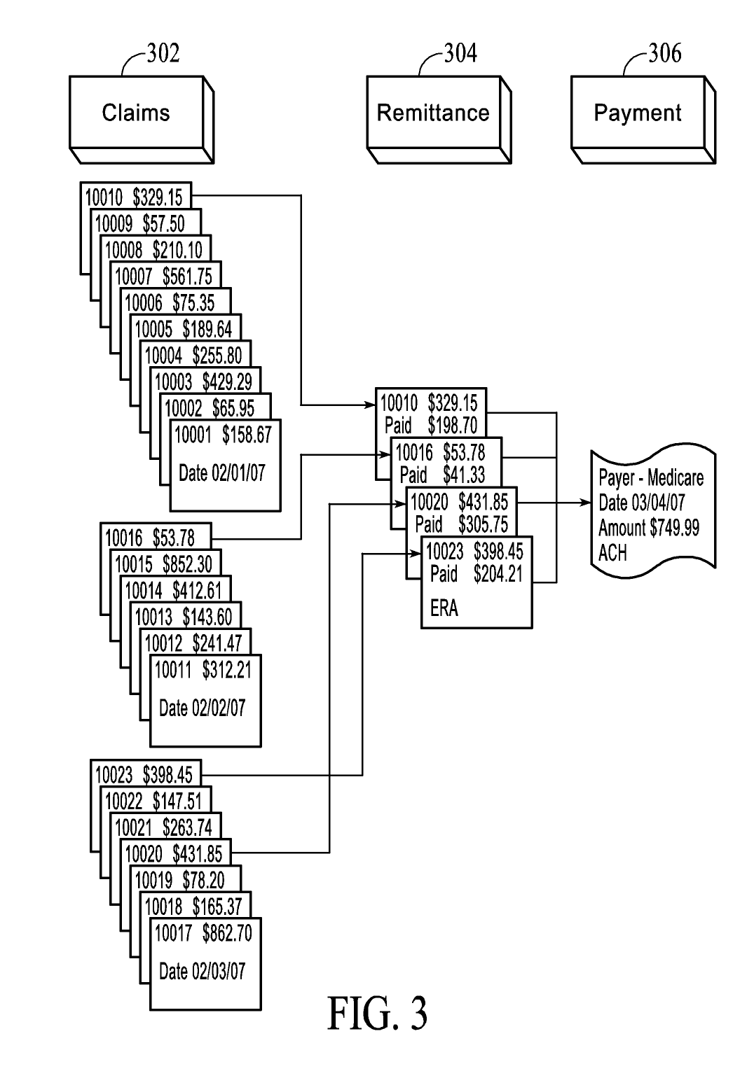

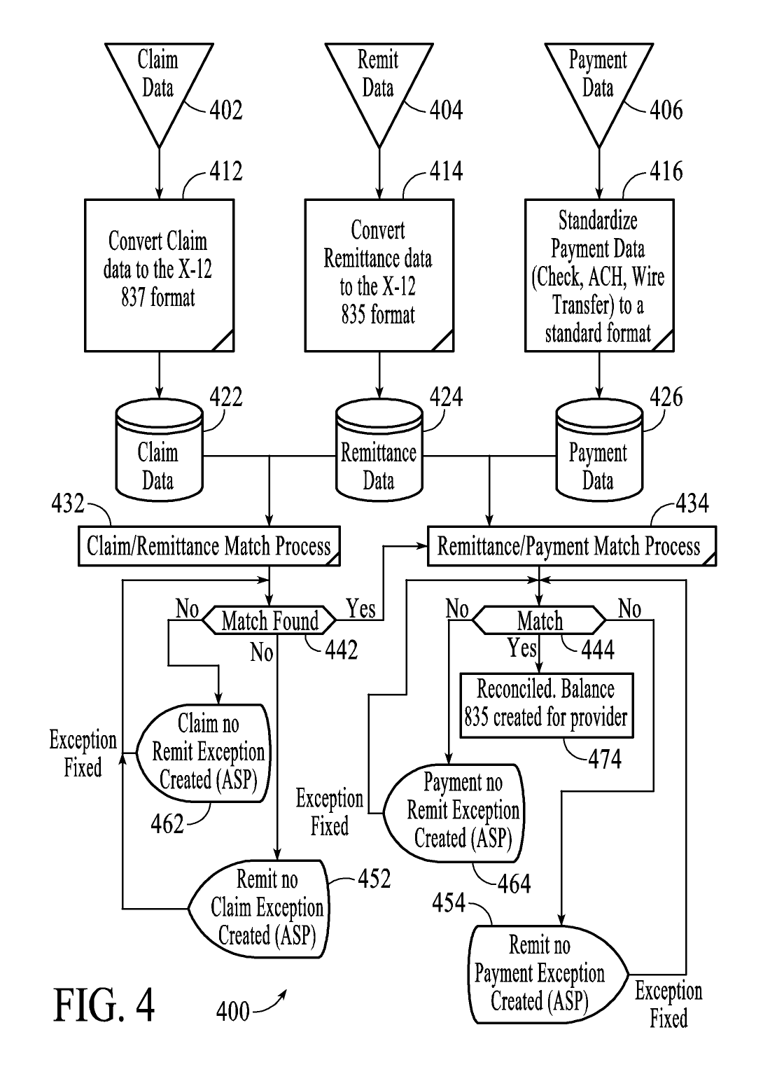

FIG. 3 shows an example of three-way matching including Matching claim 302, Remittance 304, and Payment 306, under an embodiment. FIG. 4 is a flow diagram for matching 400 the claim 402, remittance 404, and payment 406, under an embodiment. Generally, the system of an embodiment receives the claim data 402 to be provided by the healthcare provider in a timely manner (daily) so that the claim data 402 is loaded into a database before the remittance data 406 is received. When a remittance data 406 is received and a claim 402 is matched to it by the Claim/Remittance match process 432 then the claim/remit record is flagged as matched and tagged as a unique entity to which other remit and payment information can then be associated with the unique tag. Once the claim/remittance record is matched then the remittance record is sent to the Remittance/Payment match process 434, as described in detail below. Among other things, matching claim to remittance creates a certain assurance that the remittance data from the payer belongs to a specific provider. Payers frequently send one provider's remittance data to the wrong provider.

If the claim is not in the database when the remittance is received then the exception “Remit no Claim” 452 will be flagged for that remittance record. If the claim is loaded and a remittance is not matched to the claim within a set number of days then the claim record is flagged with the exception flag “Claim no Remit” 462. Both of these exceptions are sent to an exception screen within the user application for review and correction, as described in detail herein.

If the remittances are paper EOBs the embodiment utilizes Image Optical Character Recognition (IOCR) software to “lift” the data printed on the paper EOB and convert it to electronic text. This is a process that contains potential errors. Some of the information may be read incorrectly. Performing the claim-remit match can validate data that has been “lifted” with information from the claim insuring its accuracy.

In the Remittance/Payment match process 434 of an embodiment, the system receives payment data 406 from the healthcare provider's bank or other financial institution on a timely basis (e.g., daily, etc.). If the Remittance record is flagged match from the Claim/Remittance match process 432 and the payment data is not received after a pre-specified amount of time, the payment record is flagged as “Remit no Payment” 454. If the Remittance record is not matched with a claim at the Claim/Remittance match process 432 and payment data has been received then the Remittance record will be flagged as “Payment no Remit” 464. Both of these exceptions are sent to an exception screen within the user application for review and correction, as described in detail herein.

When a payment is received and it is matched to a claim/remittance by the Remittance/Payment match process 434 then the Payment record is flagged as complete because there has been a three way match of the claim, remittance, and payment. Once the Remittance/claim record is matched with a payment then the patient encounter tag(s) related to the payment are updated with payment information.

More specifically, the system of an embodiment receives claims that include claim data 402 or transaction data of transactions between providers of healthcare services and claimants. The claim data 402 is converted 412 (e.g., converted to an X-12 837 format) and stored in a repository 422 or database of claim data. The system also receives remittance data 404, where the remittance data 404 corresponds to the claims. The remittance data 404 is converted 414 (e.g., converted to an X-12 835 format) and stored in a repository 424 or database of remittance data. The system further receives payment data 406 that includes data of payments made by payers and corresponding to the claims. The payment data 406 (e.g., check, ACH, wire transfer) is standardized 416 to a standard format and stored in a repository 426 or database of payment data.

The system includes a claim/remittance match process 432 or application that matches the remittance data 404 with the claim data 402. When a match 442 is identified or found between a claim and a remittance, the system generates a first record corresponding to the matched claim/remittance combination and tags the first record with a unique tag corresponding to the claimant.

When the receiving of the remittance occurs before the receiving of any corresponding claim, then the claim/remittance match process 432 does not identify a match between any claim and any remittance and, as such, generates a first exception 452. The first exception 452 is referred to as a “Remit no Claim” exception, but is not so limited. Operation then returns to attempt to identify a match 442 between the remittance and a claim.

When the receiving of the claim occurs before the receiving of any corresponding remittance, then the claim/remittance match process 432 not identify a match between any claim and any remittance and, as such, generates a second exception 462. The second exception 462 is referred to as a “Claim no Remit” exception, but is not so limited. Operation then returns to attempt to identify a match 442 between the claim and a remittance.

When a match is identified or found between a claim and a remittance, the remittance/payment match process 434 of the system attempts to identify a match between the first record (matched claim/remittance) and a payment or payment data. When a match 444 is identified or found between the claim/remittance combination of the first record and a payment, the system flags 474 the payment record of the matched payment as complete because there has been a three way match of the claim, remittance, and payment, and updates the unique tag with the payment data of the payment.

When the receiving of the claim/remittance combination occurs before the receiving of any corresponding payment, then the remittance/payment match process 434 does not identify a match between the claim/remittance combination and any payment and, as such, generates a third exception 454. The third exception 454 is referred to as a “Remit no Payment” exception, but is not so limited. Operation then returns to attempt to identify a match 444 between the claim/remittance combination and a payment.

When the receiving of the payment occurs before the receiving of any corresponding claim/remittance combination, then the remittance/payment match process 434 does not identify a match between the payment and any claim/remittance combination and, as such, generates a fourth exception 464. The fourth exception 464 is referred to as a “Payment no Remit” exception, but is not so limited. Operation then returns to attempt to identify a match 444 between the payment and a claim/remittance combination.

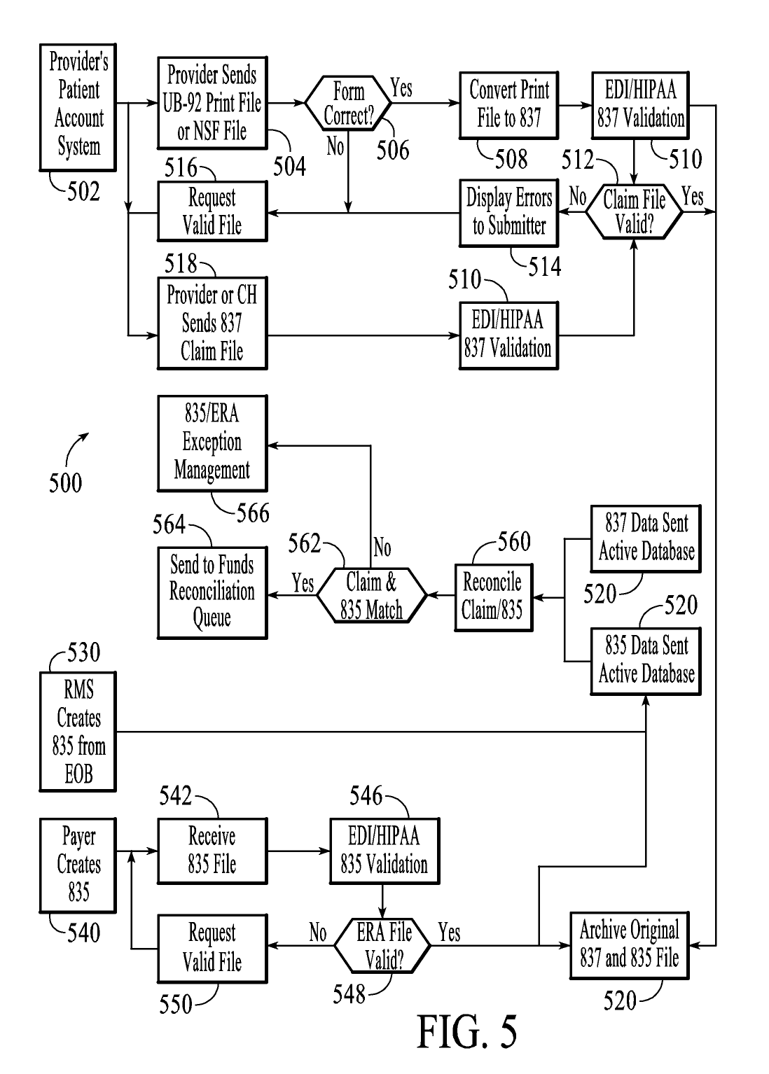

FIG. 5 is a flow diagram for matching 500 the claim and remittance, under an embodiment. This process begins with receiving the claim information from the provider. This data can be received in many different formats such as ANSI X-12 837, NSF, Misys, UB-92 or UB-04 print file, HCFA or CMS 1500 print file, to name a few. Once the data is received it is converted to a standard format like X-12 837 and loaded into a database. The claim data will stay in the database and remain unchanged except for certain flags that are used in the reconciliation and tagging process.

The Claim/Remittance match flag is enabled when a remittance has been matched with a claim. The system separates all data by the originating provider. By default, the Provider ID is always an anchor field to the matching process. Fields utilized in the matching process include, but are not limited to, the following: patient account, submitted amount and date of service. A scoring process is used which gives weights to partial and full matches of each field above. A passing flag initiates the encounter tagging process.

If the Claim/Remittance match flag has not been enabled within a pre-specified amount of time after the claim submission date, the Claim no Remit flag is enabled and an exception is generated. The exception process of an embodiment involves the provider reviewing the exception via an application for resolution, but is not so limited.

The Remit no Claim flag is enabled when a remittance transaction is received and does not match any claims in the system for a given provider. When the Remit no Claim flag is enabled the attendant exception may be reviewed. Some example reasons for the Remit no Claim flag are as follows: the patient account number field on the remittance contains truncated or added data to the original patient account number by the payer; the IOCR process did not lift the data correctly; the payer did not provide the correct patient account number on the remittance; the provider received another provider's remittance by accident.

The system of an embodiment also includes logic to reduce the number of “Remit no Claim” exceptions such as partial patient account number matching. The system reads the account number, patient first and last name, dates of service, and submitted amount from the claim. The system then uses a scoring process which assigns weights to partial and full matches of each field to obtain possible matches between claims and remittances.

Referring to FIG. 5, a healthcare provider's patient account system 502 transmits one of, for example, a UB-92 print file or NSF file, or an X-12 837 file. When the healthcare provider sends 504 a UB-92 print file or NSF file, the system determines if the form is correct 506 and, if the form is correct, converts 508 the print file or NSF file to an X-12 837. When the system determines 506 the UB-92 print file or NSF file is not correct, a request for a valid file 516 is returned to the healthcare provider's patient account system.

Following conversion 508 of the print file or NSF file to an X-12 837, the system validates 510 the X-12 837 and determines if the claim file is valid 512. When the claim file is valid, the system archives 520 the X-12 837. When the system is unable to validate 512 the X-12 837, the system presents or provides 514 the corresponding errors to the submitter and returns a request for a valid file 516 to the healthcare provider's patient account system 502.

Alternatively, when the healthcare provider sends an X-12 837 claim file 518, the system validates 510 the claim file and determines if the claim file is valid 512. When the claim file is valid, the system archives the X-12 837 520. When the system is unable to validate 512 the X-12 837, the system displays 514 the corresponding errors to the submitter and returns a request for a valid file 516 to the healthcare provider's patient account system 502.

Regarding the remittance data, the system of an embodiment creates 530 the X-12 835 using data of the EOB, and archives 520 the X-12 835. Alternatively, the system receives 542 the X-12 835 from the payer subsequent to the payer creating 540 the X-12 835. The system then validates 546 the X-12 835 and determines if the file is valid 548. When the file is valid, the system archives 520 the X-12 835. When the system is unable to validate the X-12 835, the system returns a request 550 for a valid file to the payer.

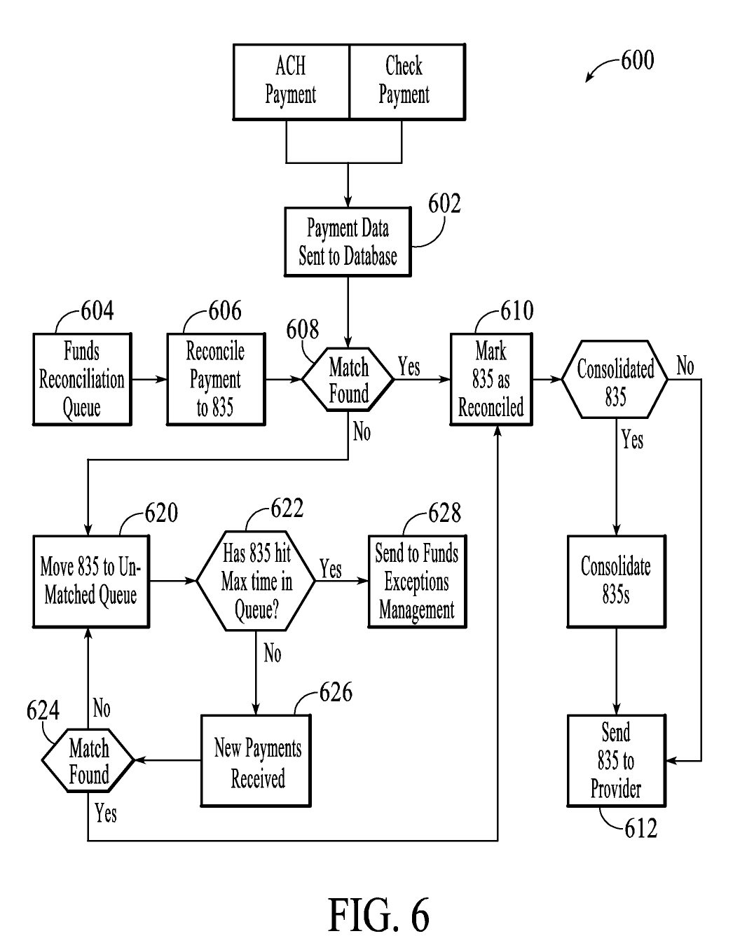

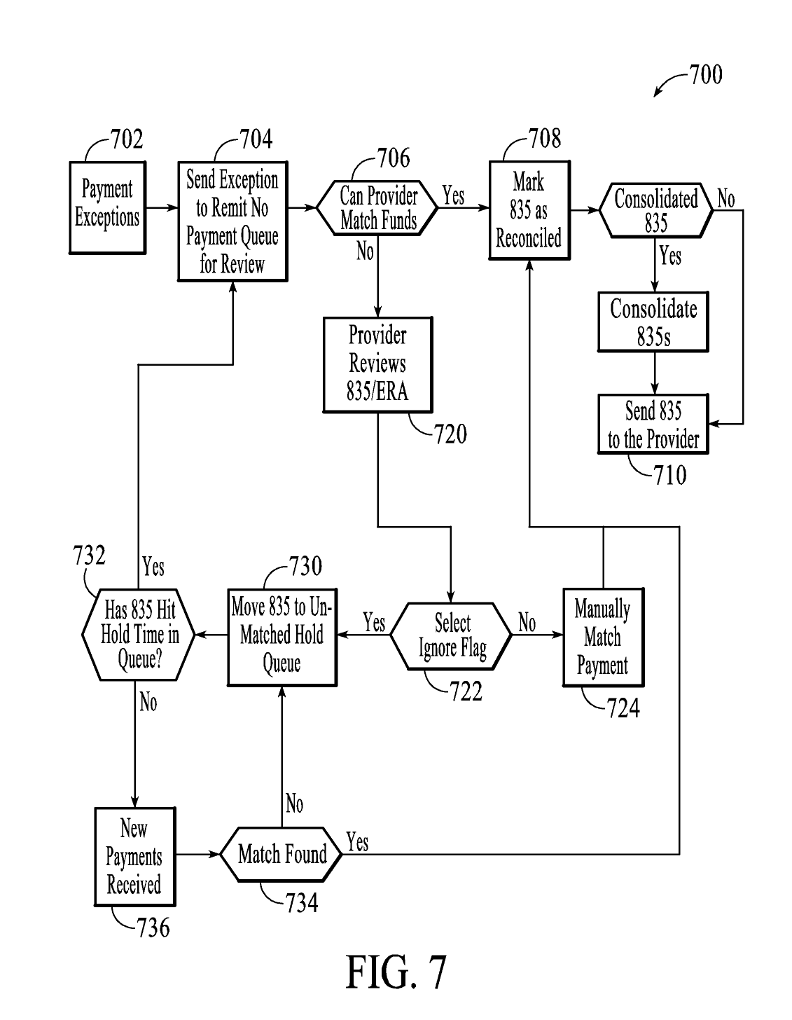

The system of an embodiment reconciles 560 the X-12 837 and 835 and determines whether there is a match 562 between the 837 and the 835. When a match 562 is identified between the 837 and 835, the system sends a record of the match to a funds reconciliation queue 564 for further processing as described in detail herein, and with reference to FIG. 6. When a match 562 is not identified between the 837 and 835, the system generates 566 one of two exceptions as described in detail herein, and the exception is sent to an exception queue for further processing as described in detail herein, and with reference to FIG. 7.

FIG. 6 is a flow diagram for matching 600 the remittance and payment, under an embodiment. Many payments are made via paper check and EOB (paper remit). In this case, the paper check is usually attached to the paper remittance and they are transmitted or sent together. Increasingly, payments are electronic funds transfers (EFT) of automated clearing houses (ACH payments). These payments are usually associated with electronic remittance advices (ERA or 835 remittance files). The EFT flows through the bank while the ERA usually travels from payer to a clearinghouse to the provider entirely bypassing the bank. Not only do the payment and remittance take different paths, often the payment and the remittance arrive on different days.

The remittance/claim matching 600 of an embodiment begins when either of the following two events occurs: patient remittance records have been matched with the associated claims and uniquely tagged by the system; payment data is received and loaded into the system. A series of events is then triggered to match Remittance records with the correct payment records.

A Remittance Payment Match Flag is set when the remittance record has been matched with the payment record. The complexity of this match depends on the method of payment and remittance media. The system automates reconciliation by holding remittances until they can be matched to the payment. There are several steps to this process. Remittances associated with Paper EOBs are usually matched to paper check payments by receiving the Bank Association Institute (BAI) file from the depository bank that details the checks deposited into a provider's bank account. If the payment is an EFT, the system utilizes ACH files from the provider's bank to reconcile with the remittance.

More specifically, and with reference to FIG. 6, payment data is received (e.g., ACH payment, check payment, etc.) and sent to or stored in a database 602 (e.g., payment database). Data of the claim/remittance match record in the funds reconciliation queue 604 is used to reconcile 606 the payment with the remittance. The system searches for a match 608 between the remittance and a payment. When a match 608 is found between the remittance and the payment, the remittance is marked as reconciled 610, and sent to the healthcare provider 612.

When the system is unable to identify a match 608 between the remittance and any payment received, the remittance is moved to or placed in an unmatched queue 620. The system monitors the period of time the remittance is in the unmatched queue. Until the remittance is determined to have been in the unmatched queue a maximum allotted time 622, the system searches for a match 624 between the remittance and new payments received 626. When a match 624 is identified between the remittance and a new payment, the remittance is marked as reconciled 610, and sent to the healthcare provider 612. When the remittance is determined 622 to have been in the unmatched queue the maximum allotted time without a match being identified with any payment, the system sends the remittance to a payment exception queue 628 for further processing as described in detail herein, and with reference to FIG. 7.

FIG. 7 is flow diagram of an exception flow 700 in the absence of a match between a remittance and a payment, under an embodiment. If the remittance/payment match flag has not been enabled within a pre-specified amount of time after the matched and tagged Claim Remittance data is received, meaning that a payment is not identified as matching the remittance, the Remit no Payment flag is set and an exception is generated. The exceptions are reviewed or analyzed via an application in an attempt to match payments with the remittance. Because of the difference in the type of work and the mix of payers, each provider is also allowed to specify the wait period before an exception is created.

The Payment no Remit flag will be enabled when the payment transaction does not match any matched and tagged remittance records in the system for a provider. The possible reasons for this are as follows: the check or trace number that came with the payment did not correctly match the check number provided in the EOB or the reassociation number in the ERA data; the ERA or EOB is not received within the time allocated by the Payment no Remit flag; the payer receives a payment that is not related to a claim (e.g., equipment reimbursement, ambulance refund, miscellaneous payment, etc.).

The system Payment Matching process of an embodiment starts with the relatively simplest data match then progresses to more complex matching algorithms. Different methods of payment each require different matching criteria. A description is provided below of possible payment match scenarios.

In a Check/EOB payment scenario, the data elements extracted from the EOB for reassociation includes check number, amount, provider ID, and payer ID. The data extracted from the check for reassociation includes check amount, check number, provider ID, routing transit number, and account number. The system determines the routing transit number and account number for a cross reference to the payer ID.

In a Check/ERA payment scenario the data elements extracted from the Check for reassociation include check number, amount, provider ID, and payer ID. The data elements extracted from the ERA for reassociation includes reassociation number, amount, provider ID, and payer ID.

In an ACH (CCD+)/EOB payment scenario the data elements extracted from the ACH for reassociation include trace number, amount, provider ID, and payer ID. The data elements extracted from the EOB for reassociation includes trace number, amount, provider ID, and payer ID.

In an ACH (CCD+)/ERA payment scenario the data elements extracted from the ACH for reassociation include trace number, amount, provider ID, and payer ID. The data elements extracted from the ERA for reassociation includes reassociation number, amount, provider ID, and payer ID.

In an ACH (CCD)/ERA payment scenario, if the payment is an ACH CCD and the remittance is an ERA, there is no reference number that ties the transactions together as in the previous cases and the logic to effect a match is more complex. The data elements extracted from the ACH for reassociation includes payment date, amount, provider ID, and payer ID. The data elements extracted from the ERA for reassociation includes payment date, amount, provider ID, and payer ID.

If a definitive match is not found, the time range is expanded by adding a pre-specified number of days (e.g., two days) and subtracting a pre-specified number of days (e.g., two days) from the effective date on the incoming payment file. Many times the payment dates are not synchronized because the bank originating the payment uses a different effective data than that of the associated remittance. If the system finds multiple matches (more than one payment with the same amount), an exception is created and the provider is required to resolve the issue through an application.

With reference to FIG. 7, a payment exception queue 702 includes data of remittances without identified matches to any payment. The Remit no Payment exception is reviewed 704 and a determination 706 is made as to whether a provider corresponding to the remittance can match the remittance with a payment. When a match is identified between the remittance and a payment, the remittance is marked as reconciled 708, and sent to the healthcare provider 710.

When the remittance is unable to be matched with a payment, the provider reviews the remittance 720 and can select an option 722 of ignoring the remittance. When the provider decides not to ignore the remittance, the provider can manually match 724 the remittance to a payment. When the provider manually matches the remittance to a payment, the remittance is marked as reconciled 708, and sent to the healthcare provider 710.

When the provider selects the option 722 to ignore the remittance, the remittance is moved to or placed in an unmatched hold queue 730. The system monitors the period of time the remittance is in the unmatched hold queue. Until the remittance is determined to have been in the unmatched hold queue a maximum allotted time 732, the system searches for a match 734 between the remittance and new payments received 736. When a match 734 is identified between the remittance and a new payment, the remittance is marked as reconciled 708, and sent to the healthcare provider 710. When the remittance is determined to have been in the unmatched hold queue the maximum allotted time 732 without a match being identified with any payment, the system places the remittance in the exception queue 704, and operation returns to make a determination 706 as to whether a provider corresponding to the remittance can match the remittance with a payment.

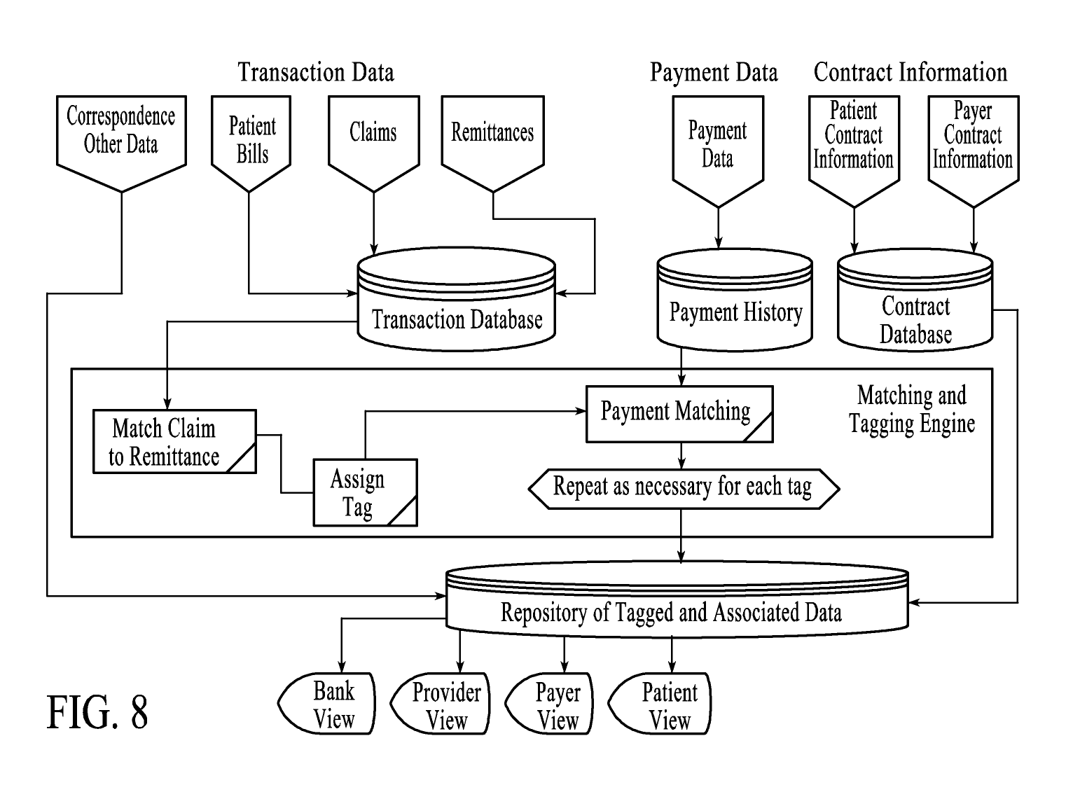

FIG. 8 is a flow diagram for tagging using the transaction platform and the associated data that is matched, associated and viewed by the various participating parties, under an embodiment. Once the payment is matched the payment information is included as part of the tag that uniquely identifies the claim, remittance, and payment related to a given patient encounter. This process is repeated until every claim or bill for the encounter is paid or denied. Many times there are secondary, and tertiary payers and a patient may pay a co-payment and/or a balance bill before every claim/bill, remittance and payment is received related to a given encounter. The system assigns a unique tag to the entire encounter each encounter is associated with one or more bills or claims, one or more remittances, one or more payments, one or more payers, a provider, a patient, one or more banks connected with the payments. Other documents such as correspondence, appeal letters, contracts, and the like can be associated with the tagged data but the claims, remittances and payments along with the patient, provider, payers and banks are the essential entities tied with the unique tag. The system authenticates providers, payers and patients and allows each to see records for which they are associated.

The transaction platform of an embodiment includes, couples to, and/or runs in conjunction with a healthcare accounts receivable valuation data consolidator (referred to herein as valuator, valuation engine or consolidator). Regardless of system configuration, the valuator comprises systems and methods for funding healthcare receivables and as such is configured to receive and/or fetch data and use the data to predict and share the valuation of claims submitted by a healthcare provider (e.g., hospital, doctor, dentist, lab, durable medical equipment provider, etc.) on behalf of a claimant (e.g., patient), wherein the claimant has a payer (e.g., insurance company, government program, etc.). The valuator established or generates and shares the predicted valuation between entities.

In contrast to conventional systems for handling healthcare receivables, the valuator provides a unique matching process that creates or generates the best estimate of the value of a healthcare receivable. The valuator also uniquely provides consolidation of the attendant information of the healthcare receivables so that the information can be accessed by all of parties involved in the healthcare process. Furthermore, the valuator provides a filter for each party involved in the healthcare process that is sensitive to the data required and the regulatory restrictions to accessing specific data, particularly private health information.

The valuator of an embodiment is configured to enable prediction of healthcare claim valuations. The valuator is also configured to enable sharing of healthcare accounts receivable or payable information between payers, providers, banks, buyers and/or sellers of healthcare accounts receivables. The valuator is generally configured to perform one or more of valuation of the receivable, financial scoring of the receivable, bidding on receivables, and sharing receivable information without sharing private information related to the individual(s) corresponding to the receivable.

The valuator of an embodiment is configured to receive and/or fetch healthcare claim and remittance advice data from healthcare providers or their agents in the form of ANSII standard X.12.837 and/or X.12.835 EDI transactions, proprietary non-standard electronic data comprised of similar information as the standards, or their paper equivalents. The valuator is configured to receive and/or fetch other relevant transaction data submitted by the provider, for example, eligibility and preauthorization transactions if they exist. The received data is automatically (e.g., electronically) scrubbed or otherwise redacted in order to eliminate information that identifies a person to whom the data corresponds. Related transactions are automatically marked to indicate an association, following the scrubbing. The valuator is configured to share the scrubbed transaction data with appropriately identified entities (e.g., hospitals, doctors, health insurance companies, banks, agents, buyers and sellers of healthcare receivables, etc.) via a network.

The valuator of an embodiment is configured to receive and/or fetch claim(s) from a provider in the form of an ANSII X.12.837 transaction or the paper equivalent. The valuator is configured to receive and/or fetch other relevant transactions submitted by the provider, including eligibility and preauthorization transactions if they exist. The valuator is configured to receive and/or fetch pricing contracts the provider has with any payer entities and/or payment schedules published by government entities. The valuator is configured to receive and/or fetch historical data related to actual payments made by insurance companies to providers for each specific procedure. The valuator is configured to receive and/or fetch auto-adjudication or pre-adjudication information from the payer. The valuator is configured to use information from the eligibility and claim transaction to gain pricing information from the provider's contract and the historical data base for use in estimating the value of each claim. The valuator is configured to automatically (e.g., electronically) reconcile the contract price/historical information to the adjudication information provided by the payer. The valuator is configured to share via a network the information with the appropriate provider, payer and/or the provider's bank for purposes of more accurately valuing the provider's receivables and possibly accelerating payment to the provider.

The transaction platform and environment shown in FIG. 1 includes the valuator but the embodiment is not so limited. For example, in an alternative embodiment, the transaction platform does not include the valuator but, instead, couples to the valuator. In another alternative embodiment, the transaction platform does not include the valuator but instead runs in conjunction or cooperation with the valuator. Regardless of system configuration, the valuator of an embodiment identifies types of receivables for which a patient is eligible by conducting eligibility checks for each patient. The valuator therefore functions to run eligibility checks and identify the patient as eligible for receivables from one or more of qualified payers (e.g., payers willing to join the network and feed information to the auto-adjudication system), non-qualified payers, Medicare or Medicaid, and/or patient responsibility (e.g., some or all of the payment is the patient's responsibility).

Regarding eligibility for receivables from qualified payers, the provider's contracts for these payers are entered into the valuator. For qualified payers eligibility is checked using an ANSI X.12.270 (request) and an ANSI X.12.271 transaction (response). This transaction identifies if the patient is eligible, the line of business from the payer (the contract has fee schedules based on line of business), the balance of the patient deductible, and/or co-pay amounts if the line of business requires them. Based on the contract, other transactions are processed if required by the contract based on information of the claim before it is submitted. For example a referral may be required by the contract based on the CPT code on the claim. Another example is a prior authorization may be required based on the information on the claim.

Before the claim is submitted, the valuator subjects the claim to a scrubber configured to perform edits for the qualified payer. If the edits identify a claim that is coded incorrectly and would be rejected by the payer, the provider is notified and has an opportunity to correct the claim before it is submitted. When the claim is submitted to the valuator the claim is valued based on the contract between the provider and the qualified payer. The qualified payers submit information to the valuator so that, before the claim is submitted, the claim is subjected to auto adjudication. The result is a value for the claim along with a value for the patient responsibility. If the contract system value and the auto-adjudication system value match, the claim is “fundable” in a pre-specified period of time (e.g., 48 hours). During the pre-specified funding time the valuator checks against fraud filters to identify fraudulent claims.

For recourse funding, the eventual amount paid is verified against the amount funded. Additionally, for recourse funding the adjustment is made before the next day's disbursements to the provider.

Claims that are not fundable either because they are not for qualified payers or because the auto-adjudication predicted value does not match the contract predicted value are categorized and submitted to an on-line trading platform (any data elements that would identify the subject patient are removed from the data so that the data can be evaluated but no privacy is violated).

Government claims cannot be bought, sold and/or factored but they can be considered as assets and valued in asset-based loans like lines of credit. This requires that the provider have an established line of credit with a bank and be able to value the claims. Therefore, the valuator of an embodiment can be used to value the claims for inclusion in asset-based lines of credit.

The valuator of an embodiment establishes a value of receivables or claims from qualified payers for a line of credit, where Medicare and Medicaid are considered qualified payers. Operation begins to establish this value by entering the provider's contracts for these payers into the valuator. For qualified payers eligibility is checked using an ANSI X.12.270 (request) and an ANSI X.12.271 transaction (response). This transaction identifies if the patient is eligible, the line of business from the payer (the contract has fee schedules based on line of business), the balance of the patient deductible, and/or co-pay amounts if the line of business requires them. Based on the contract, other transactions are processed if required by the contract based on information of the claim before it is submitted. For example a referral may be required by the contract based on the CPT code on the claim. Another example is a prior authorization may be required based on the information on the claim.

Before the claim is submitted, the valuator subjects the claim to a scrubber configured to perform edits for the qualified payer. If the edits identify a claim that is coded incorrectly and would be rejected by the payer, the provider is notified an has an opportunity to correct the claim before it is submitted. When the claim is submitted to the valuator the claim is valued based on the contract between the provider and the qualified payer. The qualified payers submit information to the valuator so that, before the claim is submitted, the claim is subjected to auto adjudication. The result is a value for the claim along with a value for the patient responsibility. If the contract system value and the auto-adjudication system value match, the claim is “verified” in a pre-specified period of time (e.g., 48 hours). During the pre-specified verification period the valuator checks against fraud filters to identify fraudulent claims. At the conclusion of the verification period the claim amount is added to the available line of credit for the provider. When the claim is subsequently paid the claim amount is automatically deducted from the provider's available line of credit.

Regarding receivables that fall into the category of patient responsibility, as described above, the valuator automatically posts the patient responsibility for qualified payers, government payers, and/or uninsured patients. Based on other demographic information gathered by the provider the valuator assesses the patient's ability to pay the amount required (e.g., the valuator can use credit checks to score each patients ability to pay, etc.). The provider is then presented options based on the patient's ability to pay as determined by the evaluator. For example, the provider can be presented one or more of the following options, but is not so limited: sell the receivable on an on-line trading platform; establish a medical credit card for qualified patients; establish a payment plan for the patient that automatically and periodically (e.g., weekly, monthly, etc.) deducts money from an established account; discount the amount owed and chose a payment strategy from those described herein; assign the service as a charitable contribution; attempt to recover some of the money owed by the patient by connect to an automated service that attempts to qualify the patient for registered government and/or charitable programs.

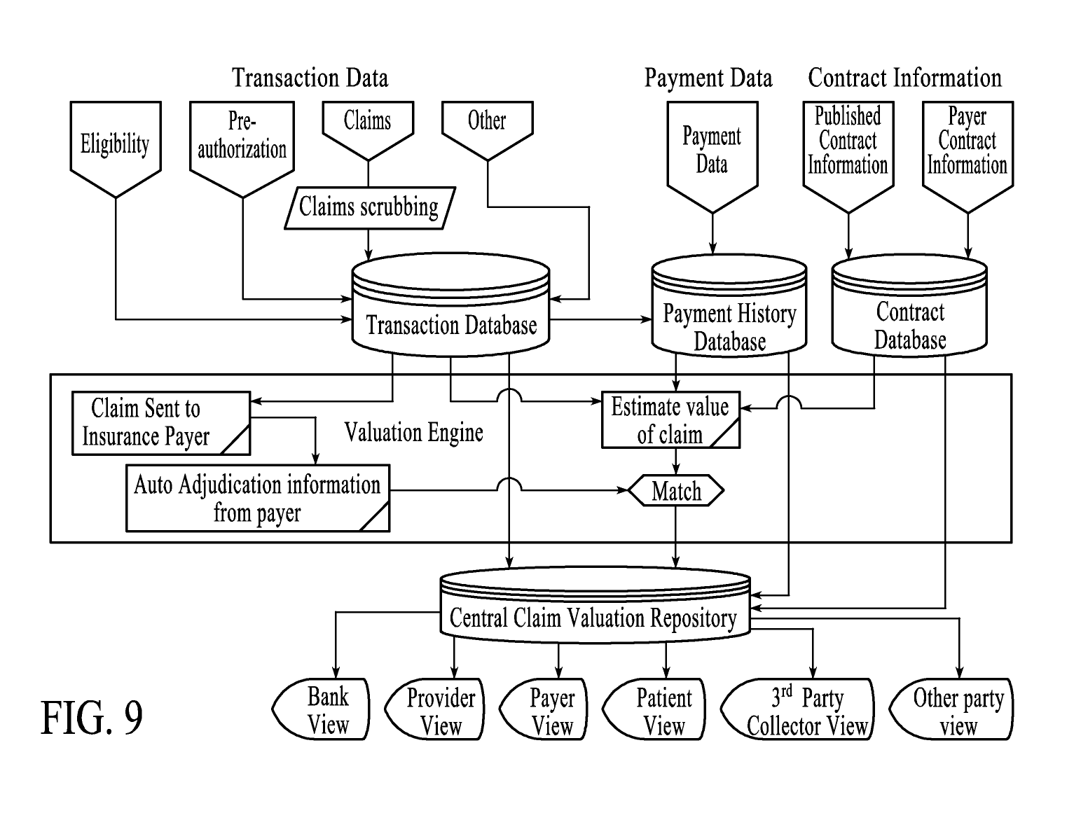

More specifically, FIG. 9 is a block diagram of a healthcare receivables system including the valuator, under an embodiment. The valuator, also referred to as the valuation engine, gathers data from disparate sources as described above. The data gathered generally includes transaction data, payer contract information, and payment data or payment history data, as described in detail below.

The transaction data includes data of a transaction between a patent and a provider. The provider's accounting system (e.g., practice management system, hospital information system, etc.) produces a claim, which is a bill for the services rendered to a patient during a visit to the provider. The valuator receives the claim information from the provider's accounting system or the provider's clearing house. Receipt of the claim information is accomplished via a file transfer that contains the data either in the form of an image of the paper claim, a print file, an ANSI standard formatted EDI file, or a non-standard format file that includes the claim information.

The valuator also gathers information about other transactions related to a patient visit. Depending on the patient and the diagnosis or treatment, these transactions include eligibility transactions that validate the exact type of insurance a patient has and that they are still in good standing with an insurance company at the time the patient visits the provider. The data of other transactions can also include any pre-authorization (e.g., provided by insurer) for a particular test or procedure indicating that the insurer agreed to pay for the procedure before it was accomplished. Furthermore, the data of other transactions can also include any data of a referral of the patient to a specialist by a general practitioner required by the patient's insurer before they will pay for the specialist's services. The data related to each patient visit is received into the transaction database.

Payer contract information or data is also received by the valuator. Providers typically have contracts with several different insurance companies. Among other things covered in the contract, the contract will contain a fee schedule that addresses the amount the insurance company will pay the healthcare provider for given procedures that the doctor or hospital may perform on a patient during a patient visit. There may also be a set of rules related to which procedures are covered by the insurance company and which procedures are not covered. This information is extracted from the contract by the valuator and loaded into the contract database along with similar information from the government (e.g., Medicare, Medicaid, etc.) that is published by procedure and geographic location.

The valuator receives payment history information and loads the payment information into a payment history database as described below. In some cases, doctors and hospitals will treat patients who have insurance plans issued by companies with which the provider does not have a contractual relationship. Services provided in these situations are often referred as “out of network” services. The insurance company typically will pay the provider a fee or a percentage of a fee based on a standard fee schedule. Over time, the payment history for given procedures that are paid by a given insurance company provides a basis for estimating the amount an insurance company will pay. The payment history information can also be a valuable predictor of future payments, even if the provider has a contract with the insurance company.

Following retrieval or gathering of the transaction data, payer contract information, and payment history data, as described above, the data is submitted to the valuator. The valuator receives feeds from the data bases described above and also receives a feed from the payers (e.g., heath insurance company, government agency, etc.) auto adjudication process. Most insurance payers pass information through an automated process that applies business rules to each claim and assigns values to the claim. This pre-adjudication is followed in some cases by other processes but the results of this process are useful in estimating the claim.

For each claim, the valuator receives transaction information from the transaction database and estimates the value of the claim. The estimate is based on information that comes from the contract database and from the payment history database. Once an estimate of the claim's value is achieved, it is matched to information received from the payer's auto adjudication process. The valuation matches the estimated value with the auto adjudication value and passes the results to a central claim valuation repository.

The valuator of an embodiment includes a scoring mechanism that enables a user to assign weights to the historical information and the contract information for each different payer of a claim in order to obtain the estimated value. The weights can be generated automatically based on information entered into the valuator or, alternatively, the valuator accepts weights entered directly by the user.

The valuator of an embodiment automatically deducts the patient's responsibility from the estimated value to obtain the judged estimated value. In particular, this automatic deduction operation is applied when the eligibility transaction data reveals that the patient owes a co-payment, a deductable amount, or has some other responsibility for a portion of the bill, but the embodiment is not so limited.

The valuator of an embodiment enables the user to assign business rules to be automatically applied by the valuator to the comparison of the auto adjudication amount and the judged estimated value. As an example of rule assignment, if the difference between the auto adjudication amount and the judged estimated value is less than a prespecified percentage (e.g., one (1) percent, two (2) percent, etc.) of the auto adjudication amount, then the auto adjudication amount is selected for use, otherwise the sum of the estimated amount plus the auto-adjudication amount divided by two (2) is selected for use.

The central claim repository holds all of the information gathered and all of the results of the various processes applied by the valuator. The information available through the central claim repository includes all transactions related to a particular claim. The central claim repository also includes the history of payments made by an insurance company for the same procedure(s) of a claim. The central claim repository further includes the results of a claim valuation estimate based on payment history and the provider's contract. Moreover, the information available through the central claim repository includes the results of the payer's auto adjudication/pre-adjudication process; additionally, the central claim repository includes data as to how closely the claim valuation estimates match the auto adjudication result. The information available through the central claim repository also includes data as to existence of a record of the transactions (e.g., referrals, pre-authorizations, eligibility, etc.) required by contract by the payer. Furthermore, where permissible by law, the central claim repository provides or enables analysis of aggregate information across payers and providers where the privacy of the patient is protected.

There are various stakeholders that have a need to access the data in order to conduct business, and the central claim repository controls and provides this access. These stakeholders include the healthcare provider and the payer but are not so limited. They also include the payer or the provider's bank, the patient, a third party collector, and/or other parties for which the ability to access and analyze the aggregate data may be useful. An example of an entity that may wish to analyze the data includes the Center for Disease Control when evaluating the rate at which a disease spreads based on the data of the central claim repository. Another example includes the American Hospital Association or a similar organization that may be analyzing the data in order to suggest best practices to their members based on data in the central claim repository.

When accessing data of the central claim repository, the valuator enables each party to access and view data based on the party's requirement to see the data but taking into account any regulatory requirements related to the information that can be viewed. For instance a provider and a patient may be able to view private health information that, as a result of HIPAA or other regulations or restrictions, a bank may not view. Aggregate data may be further restricted with respect to the identity of the patient and in some cases even the payer and or the provider.

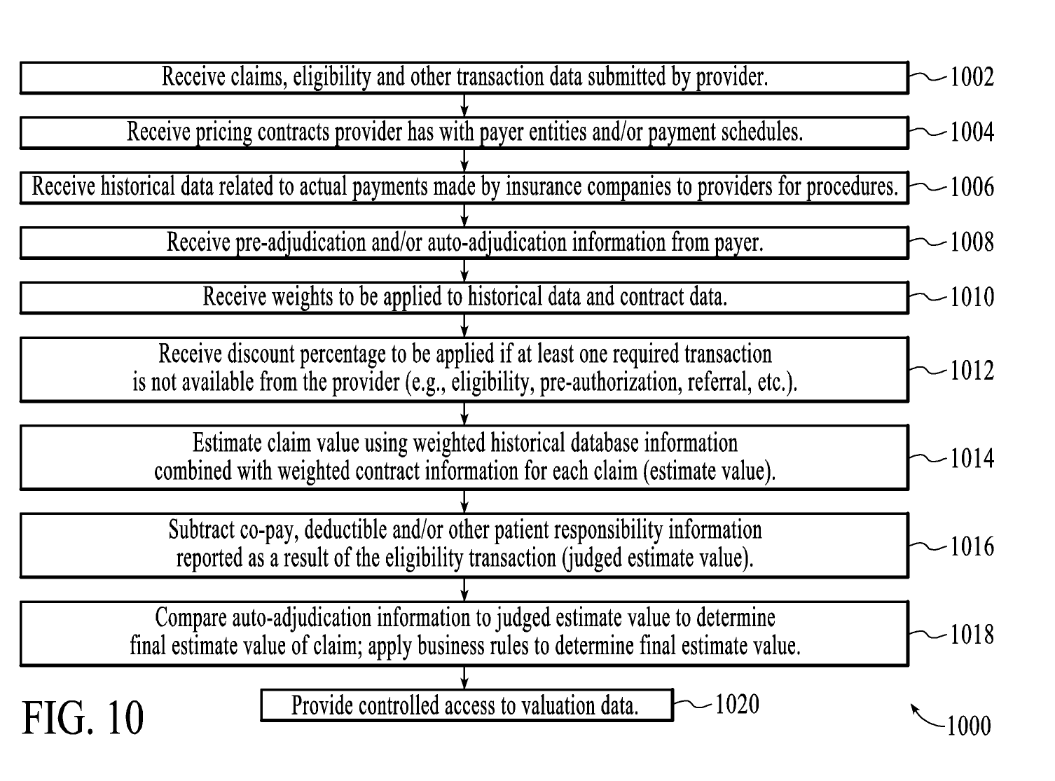

FIG. 10 is a flow diagram of claim valuation 1000, under an embodiment. The valuator of an embodiment receives or fetches claim(s) from a provider, along with other relevant transactions submitted by the provider (e.g., eligibility transactions, preauthorization transactions, etc.) 1002. The valuator receives or fetches pricing contracts the provider has with any payer entities and/or payment schedules published by government entities 1004. Historical data related to actual payments made by insurance companies to providers for each specific procedure is received or fetched 1006. The valuator also receives or fetches pre-adjudication or auto-adjudication information from the payer 1008. The valuator receives or fetches weights to be applied by the valuator to the historical data and the contract data 1010. The valuator receives or fetches any discount percentages to be applied when one or more required transactions are not available from the provider (e.g., eligibility, pre-authorization, referral, etc.) 1012. The valuator estimates the claim value using weighted historical information combined with weighted contract information for each claim to generate an estimate value or predicted value 1014. The valuator subtracts from the estimate value any co-pay, deductible and/or other patient responsibility amount reported as a result of the eligibility transaction, and the resulting value is the judged estimate value 1016. The valuator compares the auto-adjudication information to the judged estimate value to determine the final estimate value of the claim 1018. In generating the final estimate value of the claim, the valuator can apply business rules to the comparison of the auto adjudication amount and the judged estimated value. The valuator provides 1020 the final estimate value via controlled access by remote client devices over a network.

Embodiments described herein include a method running on a processor. The method of an embodiment comprises receiving a plurality of claims. Each claim includes transaction data of a transaction between a provider of healthcare services and a claimant. The method of an embodiment comprises receiving remittance data that includes data of a plurality of remittances corresponding to the plurality of claims. The method of an embodiment comprises receiving payment data that includes data of a plurality of payments made by a plurality of payers and corresponding to the plurality of claims. The method of an embodiment comprises matching a remittance of the plurality of remittances with a claim of the plurality of claims. The remittance corresponds to the claim. The method of an embodiment comprises generating a first record corresponding to the matched claim and remittance combination and tagging the first record with a unique tag corresponding to the claimant. The method of an embodiment comprises, subsequent to the generating of the first record, matching the first record with a payment of the plurality of payments. The payment corresponds to the claim and the remittance of the first record. The method of an embodiment comprises flagging the payment data of the payment as complete and updating the unique tag with the payment data of the payment.

Embodiments described herein include a method running on a processor, the method comprising: receiving a plurality of claims, wherein each claim includes transaction data of a transaction between a provider of healthcare services and a claimant; receiving remittance data that includes data of a plurality of remittances corresponding to the plurality of claims; receiving payment data that includes data of a plurality of payments made by a plurality of payers and corresponding to the plurality of claims; matching a remittance of the plurality of remittances with a claim of the plurality of claims, wherein the remittance corresponds to the claim; generating a first record corresponding to the matched claim and remittance combination and tagging the first record with a unique tag corresponding to the claimant; subsequent to the generating of the first record, matching the first record with a payment of the plurality of payments, wherein the payment corresponds to the claim and the remittance of the first record; and flagging the payment data of the payment as complete and updating the unique tag with the payment data of the payment.

The method of an embodiment comprises, when the receiving of the remittance occurs before the receiving of the claim, generating a first exception for the remittance data of the remittance.

The method of an embodiment comprises, following the receiving of the plurality of claims and in absence of a match of the remittance with the claim within a period of time, generating a second exception for the claim.

The method of an embodiment comprises, when the generating of the first record occurs before the receiving of the payment, generating a third exception for the payment data of the payment.

The method of an embodiment comprises, following the generating of the first record and in absence of a match of the first record with the payment within a period of time, generating a fourth exception for the remittance data of the remittance.

The method of an embodiment comprises matching the remittance with a new payment, wherein the new payment is received subsequent to a match attempt previously performed.

The plurality of claims of an embodiment is electronic claims.

The method of an embodiment comprises automatically validating the plurality of claims.

The plurality of remittances of an embodiment is electronic remittances.

The method of an embodiment comprises automatically validating the plurality of remittances.

The method of an embodiment comprises reconciling the plurality of claims.

The unique tag of an embodiment includes identifying data of the claim.

The unique tag of an embodiment includes identifying data of the remittance.

The unique tag of an embodiment includes identifying data of the payment.

The unique tag of an embodiment includes identifying data of the claimant.

The unique tag of an embodiment includes identifying data of the payer.

The unique tag of an embodiment includes identifying data of the provider.

The unique tag of an embodiment includes identifying data of at least one of the claim, the remittance, the payment, the claimant, the payer, and the provider.

The unique tag of an embodiment includes identifying data of the claim, the remittance, the payment, the claimant, the payer, and the provider.

The transaction of an embodiment is treatment of the claimant by the provider.

The receiving of the plurality of claims, the remittance data, and the payment data of an embodiment comprises receiving via an electronic file transfer.

The method of an embodiment comprises receiving contract data of at least one contract between the claimant and a payer.

The method of an embodiment comprises receiving payment data that includes data of actual payments made by a plurality of payers for the healthcare services.

The method of an embodiment comprises automatically generating a predicted value of the claim from the contract data and the payment data.

The method of an embodiment comprises providing controlled electronic access to the value by at least one third party.

Embodiments described herein include a system comprising a transaction platform that includes at least one processor and at least one database coupled to a plurality of remote clients via a network. The transaction platform of an embodiment receives a plurality of claims. Each claim includes transaction data of a transaction between a provider of healthcare services and a claimant. The transaction platform of an embodiment receives remittance data that includes data of a plurality of remittances corresponding to the plurality of claims. The transaction platform of an embodiment receives payment data that includes data of a plurality of payments made by a plurality of payers and corresponding to the plurality of claims. The transaction platform of an embodiment matches a remittance of the plurality of remittances with a claim of the plurality of claims. The remittance corresponds to the claim. The transaction platform of an embodiment generates a first record corresponding to the matched claim and remittance combination and tags the first record with a unique tag corresponding to the claimant. The transaction platform of an embodiment, subsequent to the generating of the first record, matches the first record with a payment of the plurality of payments. The payment corresponds to the claim and the remittance of the first record. The transaction platform of an embodiment flags the payment data of the payment as complete and updating the unique tag with the payment data of the payment.

Embodiments described herein include a system comprising: a transaction platform comprising at least one processor and at least one database coupled to a plurality of remote clients via a network; wherein the transaction platform receives a plurality of claims, wherein each claim includes transaction data of a transaction between a provider of healthcare services and a claimant; wherein the transaction platform receives remittance data that includes data of a plurality of remittances corresponding to the plurality of claims; wherein the transaction platform receives payment data that includes data of a plurality of payments made by a plurality of payers and corresponding to the plurality of claims; wherein the transaction platform matches a remittance of the plurality of remittances with a claim of the plurality of claims, wherein the remittance corresponds to the claim; wherein the transaction platform generates a first record corresponding to the matched claim and remittance combination and tags the first record with a unique tag corresponding to the claimant; wherein, subsequent to the generating of the first record, the transaction platform matches the first record with a payment of the plurality of payments, wherein the payment corresponds to the claim and the remittance of the first record; and wherein the transaction platform flags the payment data of the payment as complete and updating the unique tag with the payment data of the payment.

The transaction platform of an embodiment, when receiving the remittance before receiving the claim, generates a first exception for the remittance data of the remittance.

The transaction platform of an embodiment, following the receiving of the plurality of claims and in absence of a match of the remittance with the claim within a period of time, generates a second exception for the claim.

The transaction platform of an embodiment, when the generating of the first record occurs before the receiving of the payment, generates a third exception for the payment data of the payment.

The transaction platform of an embodiment, following the generating of the first record and in absence of a match of the first record with the payment within a period of time, generates a fourth exception for the remittance data of the remittance.

The transaction platform of an embodiment matches the remittance with a new payment that is received subsequent to a match attempt previously performed.

The plurality of claims of an embodiment is electronic claims.

The transaction platform of an embodiment automatically validates the plurality of claims.

The plurality of remittances of an embodiment is electronic remittances.

The transaction platform of an embodiment automatically validates the plurality of remittances.

The transaction platform of an embodiment reconciles the plurality of claims.

The unique tag of an embodiment includes identifying data of the claim.

The unique tag of an embodiment includes identifying data of the remittance.

The unique tag of an embodiment includes identifying data of the payment.

The unique tag of an embodiment includes identifying data of the claimant.

The unique tag of an embodiment includes identifying data of the payer.

The unique tag of an embodiment includes identifying data of the provider.

The unique tag of an embodiment includes identifying data of at least one of the claim, the remittance, the payment, the claimant, the payer, and the provider.

The unique tag of an embodiment includes identifying data of the claim, the remittance, the payment, the claimant, the payer, and the provider.

The transaction of an embodiment is treatment of the claimant by the provider.

The transaction platform of an embodiment receives the plurality of claims, the remittance data, and the payment data via an electronic file transfer.

The transaction platform of an embodiment receives contract data of at least one contract between the claimant and a payer.

The transaction platform of an embodiment receives payment data that includes data of actual payments made by a plurality of payers for the healthcare services.

The transaction platform of an embodiment automatically generates a predicted value of the claim from the contract data and the payment data.

The transaction platform of an embodiment provides controlled electronic access to the value by at least one third party.

The embodiments described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods described to the precise form disclosed. While specific embodiments of, and examples for, the systems and methods are described herein for illustrative purposes, various equivalent modifications are possible within the scope of other systems and methods, as those skilled in the relevant art will recognize. The teachings of the embodiments provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the embodiments described above to the specific embodiments disclosed in the specification and the claims, but should be construed to include all systems and methods that operate under the claims. Accordingly, the embodiments described above are not limited by the disclosure, but instead the scope is to be determined entirely by the claims.

While certain aspects of the embodiments described above are presented below in certain claim forms, the inventors contemplate the various aspects of the embodiments described above in any number of claim forms. Accordingly, the inventors reserve the right to add additional claims after filing the application to pursue such additional claim forms for other aspects of the embodiments described above.

What is claimed is:

1. A method running on a processor, the method comprising:
receiving a plurality of claims, wherein each claim includes transaction data of a transaction between a provider of healthcare services and a claimant;
receiving remittance data that includes data of a plurality of remittances corresponding to the plurality of claims;
receiving payment data that includes data of a plurality of payments made by a plurality of payers and corresponding to the plurality of claims;
matching a remittance of the plurality of remittances with a claim of the plurality of claims, wherein the remittance corresponds to the claim;
generating a first record corresponding to the matched claim and remittance combination and tagging the first record with a unique tag corresponding to the claimant;
subsequent to the generating of the first record, matching the first record with a payment of the plurality of payments, wherein the payment corresponds to the claim and the remittance of the first record; and
flagging the payment data of the payment as complete and updating the unique tag with the payment data of the payment.

2. The method of claim 1, comprising, when the receiving of the remittance occurs before the receiving of the claim, generating a first exception for the remittance data of the remittance.

3. The method of claim 2, comprising, following the receiving of the plurality of claims and in absence of a match of the remittance with the claim within a period of time, generating a second exception for the claim.

4. The method of claim 1, comprising, when the generating of the first record occurs before the receiving of the payment, generating a third exception for the payment data of the payment.

5. The method of claim 4, comprising, following the generating of the first record and in absence of a match of the first record with the payment within a period of time, generating a fourth exception for the remittance data of the remittance.

6. The method of claim 5, comprising matching the remittance with a new payment, wherein the new payment is received subsequent to a match attempt previously performed.

7. The method of claim 1, wherein the plurality of claims is electronic claims.

8. The method of claim 7, comprising automatically validating the plurality of claims.

9. The method of claim 1, wherein the plurality of remittances is electronic remittances.

10. The method of claim 9, comprising automatically validating the plurality of remittances.

11. The method of claim 1, comprising reconciling the plurality of claims.

12. The method of claim 1, wherein the unique tag includes identifying data of the claim.

13. The method of claim 1, wherein the unique tag includes identifying data of the remittance.

14. The method of claim 1, wherein the unique tag includes identifying data of the payment.

15. The method of claim 1, wherein the unique tag includes identifying data of the claimant.

16. The method of claim 1, wherein the unique tag includes identifying data of the payer.

17. The method of claim 1, wherein the unique tag includes identifying data of the provider.

18. The method of claim 1, wherein the unique tag includes identifying data of at least one of the claim, the remittance, the payment, the claimant, the payer, and the provider.

19. The method of claim 1, wherein the unique tag includes identifying data of the claim, the remittance, the payment, the claimant, the payer, and the provider.

20. The method of claim 1, wherein the transaction is treatment of the claimant by the provider.

21. The method of claim 1, wherein the receiving of the plurality of claims, the remittance data, and the payment data comprises receiving via an electronic file transfer.

22. The method of claim 1, comprising receiving contract data of at least one contract between the claimant and a payer.

23. The method of claim 22, comprising receiving payment data that includes data of actual payments made by a plurality of payers for the healthcare services.

24. The method of claim 23, comprising automatically generating a predicted value of the claim from the contract data and the payment data.

25. The method of claim 24, comprising providing controlled electronic access to the value by at least one third party.

26. A system comprising:
a transaction platform comprising at least one processor and at least one database coupled to a plurality of remote clients via a network;
wherein the transaction platform receives a plurality of claims, wherein each claim includes transaction data of a transaction between a provider of healthcare services and a claimant;
wherein the transaction platform receives remittance data that includes data of a plurality of remittances corresponding to the plurality of claims;
wherein the transaction platform receives payment data that includes data of a plurality of payments made by a plurality of payers and corresponding to the plurality of claims;
wherein the transaction platform matches a remittance of the plurality of remittances with a claim of the plurality of claims, wherein the remittance corresponds to the claim;
wherein the transaction platform generates a first record corresponding to the matched claim and remittance combination and tags the first record with a unique tag corresponding to the claimant;
wherein, subsequent to the generating of the first record, the transaction platform matches the first record with a payment of the plurality of payments, wherein the payment corresponds to the claim and the remittance of the first record; and
wherein the transaction platform flags the payment data of the payment as complete and updating the unique tag with the payment data of the payment.

27. The system of claim 26, wherein the transaction platform, when receiving the remittance before receiving the claim, generates a first exception for the remittance data of the remittance.

28. The system of claim 27, wherein the transaction platform, following the receiving of the plurality of claims and in absence of a match of the remittance with the claim within a period of time, generates a second exception for the claim.

29. The system of claim 26, wherein the transaction platform, when the generating of the first record occurs before the receiving of the payment, generates a third exception for the payment data of the payment.

30. The system of claim 29, wherein the transaction platform, following the generating of the first record and in absence of a match of the first record with the payment within a period of time, generates a fourth exception for the remittance data of the remittance.

31. The system of claim 30, wherein the transaction platform matches the remittance with a new payment that is received subsequent to a match attempt previously performed.

32. The system of claim 26, wherein the plurality of claims is electronic claims.

33. The system of claim 32, wherein the transaction platform automatically validates the plurality of claims.

34. The system of claim 26, wherein the plurality of remittances is electronic remittances.

35. The system of claim 34, wherein the transaction platform automatically validates the plurality of remittances.

36. The system of claim 26, wherein the transaction platform reconciles the plurality of claims.

37. The system of claim 26, wherein the unique tag includes identifying data of the claim.

38. The system of claim 26, wherein the unique tag includes identifying data of the remittance.

39. The system of claim 26, wherein the unique tag includes identifying data of the payment.

40. The system of claim 26, wherein the unique tag includes identifying data of the claimant.

41. The system of claim 26, wherein the unique tag includes identifying data of the payer.

42. The system of claim 26, wherein the unique tag includes identifying data of the provider.

43. The system of claim 26, wherein the unique tag includes identifying data of at least one of the claim, the remittance, the payment, the claimant, the payer, and the provider.

44. The system of claim 26, wherein the unique tag includes identifying data of the claim, the remittance, the payment, the claimant, the payer, and the provider.

45. The system of claim 26, wherein the transaction is treatment of the claimant by the provider.

46. The system of claim 26, wherein the transaction platform receives the plurality of claims, the remittance data, and the payment data via an electronic file transfer.

47. The system of claim 26, wherein the transaction platform receives contract data of at least one contract between the claimant and a payer.

48. The system of claim 47, wherein the transaction platform receives payment data that includes data of actual payments made by a plurality of payers for the healthcare services.

49. The system of claim 48, wherein the transaction platform automatically generates a predicted value of the claim from the contract data and the payment data.

50. The system of claim 49, wherein the transaction platform provides controlled electronic access to the value by at least one third party.
